(19) United States
(12) Patent Application Publication
(10) Pub. No.: US 2018/0020357 A1
(43) Pub. Date: Jan. 18, 2018

(54) Method and Apparatus for Acquiring Management Policy of Heterogeneous Network

(71) Applicant: ZTE CORPORATION, Shenzhen City, Guangdong Province (CN)

(72) Inventors: Yu ZHANG, Shenzhen (CN); Xinhui WANG, Shenzhen (CN); Bin WANG, Shenzhen (CN); Yongyu CHANG, Shenzhen (CN); Xinmiao LIU, Shenzhen (CN)

(21) Appl. No.: 15/547,809

(22) PCT Filed: Dec. 23, 2015
(86) PCT No.: PCT/CN2015/098423

§ 371 Date: Aug. 1, 2017

(30) Foreign Application Priority Data
Feb. 26, 2015 (CN) 201510088473.6

(51) Int. Cl. H04W 16/10; H04W 72/04; H04W 84/04

(52) U.S. Cl. CPC H04W 16/10; H04W 72/0453; H04W 84/045

(57) ABSTRACT

A method for acquiring a management policy of a heterogeneous network, including: acquiring a feasible frequency allocation policy of a small cell network when there is only the small cell network in a heterogeneous network (101); in each frequency allocation policy, when the heterogeneous network includes a device-to-device network, determining an optimal resource allocation policy of the device-to-device network (102); calculating a capacity of the heterogeneous network under each frequency allocation policy and the optimal resource allocation policy corresponding to the each frequency allocation policy, obtaining at least two capacities of the heterogeneous network (103); and obtaining a frequency allocation policy and a resource allocation policy of the heterogeneous network according to at least two capacities of the heterogeneous network (104).

### TECHNICAL FIELD

The present disclosure relates to, but is not limited to, a resource allocation technique in the field of wireless communications, and more particularly to a method and apparatus for acquiring a management policy of a heterogeneous network.

### BACKGROUND

The arrival of the fifth generation mobile communication technology (5G) embodies the rapid development of wireless communication technology, followed by the explosive growth of wireless communication device and service data. The massive growth of data transmission services brings a challenge that a wireless network is increased in thousands of capacity, and deploying the Dense Network to meet indoor and outdoor data and coverage requirements is an inevitable technology trend. Therefore, a small cell with low-power and small coverage begins to enter the sight of people.

Small Cell as a base station device with small coverage, low-power, is a supplement to the macro cellular of the third generation mobile communication technology (3G)/the fourth generation mobile communication technology (4G) for operators to provide better wireless broadband voice and data services for users in lower prices. The coverage of the small cell is 10˜200 m, and the small cell is used as a wireless access node to work at low power in the authorized spectrum.

Dense network has a huge traffic demand, and the communication area is always concentrated. Although the high density of the small cell can guarantees the system capacity, it leads to the serious interference between the adjacent small cells. Therefore, the Device-to-Device (D2D) communication is introduced to share the dense network traffic. In addition, D2D communication also brings the advantages, such as, reducing battery power consumption of a mobile terminal, increasing bit rate, and supporting a new type of small-scale point-to-point data service and the like. The D2D communication is introduced into the small cell network to the form heterogeneous network. Herein, in the small cell network, same frequency multiplexing is performed inter-small-cell, and the orthogonal frequency resource is used intra-small-cell; same frequency multiplexing is performed on the introduced D2D communication and the small cell resources, and same frequency multiplexing is also performed inter-D2D.

There is no power control in the downlink of the Long Term Evolution (LTE), so the communication quality of the User Equipment (UE) at the coverage area edge of the Small Cell evolved NodeBs cannot be guaranteed. Although the introduction of D2D communication effectively alleviate this problem, however, the accompanying interference between D2D and small cell is also unavoidable. D2D will bring the interference to the Small Cell UE (SUE) serviced by SeNB, and meanwhile, the D2D itself is also interfered by SeNB. Compared to the power of D2D, the power of SeNB is relatively large, so the interference of SeNB to the D2D is large. Therefore, though the introduced D2D has shared the system's traffic load, however, the user's Quality of Service (QoS) cannot be guaranteed. On the other hand, though the low power of the D2D has small interference to the SUE, the low power of the D2D itself makes the system capacity lower than that of the case where there is only a small cell. At the same time, the QoS of all access users cannot be guaranteed.

In summary, in the heterogeneous network composed by the small cell network and D2D communications, though the system performance (especially the system performance of dense networks) can be significantly improved by sharing core network traffic and reducing overall energy consumption, however, the introduction of D2D communication will also bring a lot of potential problems. Herein, the problem of wireless resource allocation of the small cell network or D2D communication has been paid attention, but the heterogeneous network formed after the introduction of D2D, that is, the scenario of the coexistence of two communication modes in the network, is rarely considered. Based on the above-mentioned scenario, at present, there is no rational resource allocation scheme that not only guarantees the QoS of all the access users but also maximizes the throughput of the entire system.

### SUMMARY

The following is a summary of the subject that is described in detail in the document. The summary is not intended to limit the protective scope of the claims.

Embodiments of the present disclosure provide a method and an apparatus for acquiring a management policy of a heterogeneous network, which can maximize the system capacity while guaranteeing the QoS of each user in the heterogeneous network, to improve the system performance.

To achieve the above object, an embodiment of the present disclosure provides a method for acquiring a management policy of a heterogeneous network, including: acquiring a feasible frequency allocation policy of a small cell network when there is only a small cell network in the heterogeneous network; in each frequency allocation policy, when the heterogeneous network includes a device-to-device, D2D, network, determining an optimal resource allocation policy of the device-to-device network; calculating a capacity of the heterogeneous network under the each frequency allocation policy and the optimal resource allocation policy corresponding to the each frequency allocation policy, obtaining at least two capacities of the heterogeneous network; and obtaining a frequency allocation policy and a resource allocation policy of the heterogeneous network according to the at least two capacities of the heterogeneous network.

In each frequency allocation policy, when the heterogeneous network includes a device-to-device network, determining an optimal resource allocation policy of the device-to-device network, includes: in the each frequency allocation policy, determining the optimal resource allocation policy of the D2D network by using a block coordinated descent optimization algorithm and by calculating a ratio of a throughput of the device to device network to a throughput of the small cell network.

Calculating a capacity of the heterogeneous network under the each frequency allocation policy and the optimal resource allocation policy corresponding to the each frequency allocation policy includes: according to u_{0,th} and ρ, determining the capacity of the heterogeneous network under the each frequency allocation policy and the optimal resource allocation policy corresponding to the each frequency allocation policy; herein, u_{0,th} is a communication capacity of the small cell network, when γ_{n,k}^{DUE}=γₜₕ^{DUE}, herein, γ_{n,k}^{DUE} represents a Signal to Interference plus Noise Ratio (SINR) of an nth terminal of the small cell network on a kth block resource, and γₜₕ^{DUE} represents a preset SINR threshold value of a receiving end of the device to device network; herein, ρ represents a maximum ratio of the communication capacity of the small cell network to the communication capacity of the device-to-device network.

Herein,

$${γ}_{n , k}^{DUE} = \frac{{p}_{n , k}^{DUE} \cdot {h}_{n , n , k}^{ 3}}{{\sum }_{m = 1}^{M} {p}_{m , k}^{SUE} \cdot {h}_{m , n , k}^{ 4} + {n}_{0}}$$

p_{n,k}^{DUE} represents transmission power of a D2D terminal numbered n on the kth resource block RB;

h_{n,n,k}³ represents a channel gain between an nth D2D transmitter and an nth receiver on the kth bandwidth RB;

p_{m,k}^{SUE} represents transmission power for a small cell evolved base station SeNB on the kth bandwidth RB to an mth small cell terminal [symbol] UEₘ;

h_{m,n,k}⁴ represents a channel gain between a small cell evolved base station [symbol] eNBₘ numbered m on the kth bandwidth RB and the nth D2D receiver; and

n₀ represents background noise.

Herein, the capacity of the heterogeneous network is U≈u_{0,th}·(1+1/ρ); herein:

$${u}_{0 , th} = {\sum }_{k = 1}^{K} \begin{matrix}M \\ m = 1\end{matrix} {x}_{m , k} \cdot {B}_{0} \cdot log ( 1 + {γ}_{th}^{ SUE} )$$

herein, k represents a kth bandwidth in a downlink total bandwidth with K bandwidths, [symbol] ={1, . . . k, . . . , K};

m represents an mth terminal in terminals, a total number of which is M, of the heterogeneous network, [symbol] ={1, . . . , m, . . . , M};

x_{m,k}=1 represents that the kth resource block is allocated to the small cell network user equipment m, and x_{m,k}=0 represents that the kth resource block is not allocated to the small cell network user equipment m;

B₀ represents a bandwidth size of a unit resource block; and

γₜₕ^{SUE} represents a preset SINR threshold value of the receiving end in the small cell network.

Herein, obtaining a frequency allocation policy and a resource allocation policy of the heterogeneous network according to the at least two capacities of the heterogeneous network, includes: according to a maximum value of the at least two capacities of the heterogeneous network, determining the frequency allocation policy and the resource allocation policy of the heterogeneous network corresponding to the maximum value.

An embodiment of the present disclosure further provides an apparatus for acquiring a management policy of a heterogeneous network, including: an acquiring module, configured to acquire a feasible frequency allocation policy of a small cell network when there is only the small cell network in the heterogeneous network; a first determining module, configured to in each frequency allocation policy, when the heterogeneous network includes a device-to-device, D2D, network, determine an optimal resource allocation policy of the device-to-device network; a calculating module, configured to calculate a capacity of the heterogeneous network under the each frequency allocation policy and the optimal resource allocation policy corresponding to the each frequency allocation policy, obtain at least two capacities of the heterogeneous network; and a second determining module, configured to obtain the frequency allocation policy and the resource allocation policy of the heterogeneous network according to at least two capacities of the heterogeneous network.

Herein, the first determining module is configured to: in the each frequency allocation policy, determine the optimal resource allocation policy of the D2D network by using a block coordinated descent optimization algorithm and by calculating a ratio of a throughput of the device to device network to a throughput of the small cell network.

Herein, the calculating module is configured to, according to u_{0,th} and ρ, determine the capacity of the heterogeneous network under the each frequency allocation policy and the optimal resource allocation policy corresponding to the each frequency allocation policy; herein, u_{0,th} is a communication capacity of the small cell network when γ_{n,k}^{DUE}=γₜₕ^{DUE}; herein, γ_{n,k}^{DUE} represents a Signal to Interference plus Noise Ratio (SINR) of an nth terminal of the small cell network on a kth block resource, and γₜₕ^{DUE} represents a preset SINR threshold value of a receiving end of the device to device network; herein, ρ represents a maximum ratio of the communication capacity of the small cell network to the communication capacity of the device-to-device network.

Herein,

$${γ}_{n , k}^{DUE} = \frac{{p}_{n , k}^{DUE} \cdot {h}_{n , n , k}^{ 3}}{{\sum }_{m = 1}^{M} {p}_{m , k}^{SUE} \cdot {h}_{m , n , k}^{ 4} + {n}_{0}}$$

p_{n,k}^{DUE} represents transmission power of a D2D terminal numbered n on the kth resource block RB;

h_{n,n,k}³ represents a channel gain between an nth D2D transmitter and an nth receiver on the kth bandwidth RB;

p_{m,k}^{SUE} represents transmission power for a small cell evolved base station SeNB on the kth bandwidth RB to an mth small cell terminal [symbol] UEₘ;

h_{m,n,k}⁴ represents a channel gain between a small cell evolved base station [symbol] eNBₘ numbered m and nth D2D receiver on the kth bandwidth RB; and

n₀ represents background noise.

Herein, the capacity of the heterogeneous network is U≈u_{0,th}·(1+1/ρ); herein:

$${u}_{0 , th} = {\sum }_{k = 1}^{K} {M}_{m = 1} {x}_{m , k} \cdot {B}_{0} \cdot log ( 1 + {γ}_{th}^{SUE} )$$

herein, k represents a kth bandwidth in a downlink total bandwidth with K bandwidths, [symbol] ={1, . . . k, . . . , K};

m represents an mth terminal in terminals, a total number of which is M, of the heterogeneous network, [symbol] ={1, . . . , m, . . . , M};

x_{m,k}=1 represents that the kth resource block is allocated to the small cell network user equipment m, and x_{m,k}=0 represents that the kth resource block is not allocated to the small cell network user equipment m;

B₀ represents a bandwidth size of a unit resource block; and

γₜₕ^{SUE} represents a preset SINR threshold value of the receiving end in the small cell network.

Herein, the second determining module is configured to, according to a maximum value of the at least two capacities of the heterogeneous network, determine the frequency allocation policy and the resource allocation policy of the heterogeneous network corresponding to the maximum value.

An embodiment of the present disclosure further provides a computer-readable storage medium storing a computer-executable instruction, and when the computer-executable instruction is executed, it implements the above-mentioned method for acquiring a management policy of a heterogeneous network.

The embodiments of the present disclosure can provide a resource allocation scheme that satisfies QoS of all access users and find one resource allocation scheme where the throughput of the heterogeneous network can reach the maximum. In this way, it not only guarantees the quality of service (QoS) of all access users, but also achieves the maximization of the throughput of the entire heterogeneous network.

Other features and advantages of the embodiments of the present disclosure are described in the following description, and become obvious from parts of the description, or are understood by implementing the present disclosure. The purpose and other advantages of the present disclosure can be implemented and obtained by the structure which is specified in the description, claims and accompanying drawings.

After reading and understanding the drawings and detailed description, other aspects can be understood.

### BRIEF DESCRIPTION OF DRAWINGS

The accompanying drawings described herein are used to provide a further understanding for the embodiments of the present disclosure and constitute a part of the present disclosure. The exemplary embodiments of the present disclosure and the description thereof are used to explain the present disclosure, rather than constituting an inappropriate limitation to the present disclosure. In the drawings:

FIG. 1 is a flowchart of a method for acquiring a management policy of a heterogeneous network provided by an embodiment of the present disclosure.

FIG. 2 is a flowchart of a method for acquiring a resource allocation scheme of a heterogeneous network provided by an embodiment of the present disclosure.

FIG. 3 is a schematic diagram of a scenario of a heterogeneous network composed by a small cell network and D2D network.

FIG. 4 is a structural schematic diagram of an apparatus for acquiring a management policy of a heterogeneous network provided by an embodiment of the present disclosure.

### DETAILED DESCRIPTION

Hereinafter in conjunction with the accompanying drawings, the embodiments of the present disclosure will be described in detail. It should be illustrated that, under the situation of no conflict, the embodiments and the features of the embodiments in the present disclosure can be arbitrarily combined with each other.

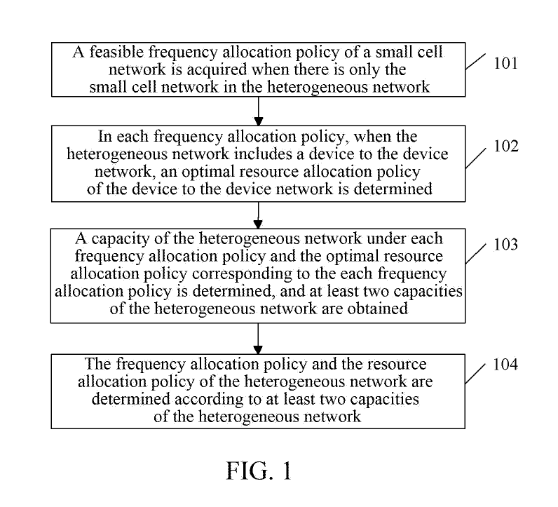

FIG. 1 is a flowchart of a method for acquiring a management policy of a heterogeneous network provided by an embodiment of the present disclosure. The method shown in FIG. 1 includes the following steps 101-104.

In step 101, a feasible frequency allocation policy of a small cell network is acquired when there is only the small cell network in the heterogeneous network.

In step 102, in each frequency allocation policy, when the heterogeneous network includes a device-to-device (D2D) network, an optimal resource allocation policy of the device-to-device network is determined.

In step 103, a capacity of the heterogeneous network is determined under each frequency allocation policy and the optimal resource allocation policy corresponding to the each frequency allocation policy, and at least two capacities of the heterogeneous network are obtained.

In step 104, the frequency allocation policy and the resource allocation policy of the heterogeneous network are determined according to at least two capacities of the heterogeneous network.

The method provided by the embodiments of the present disclosure can provide a resource allocation scheme that satisfies the quality of service (QoS) of all access users, and finds a resource allocation scheme where the throughput of the heterogeneous network can reach the maximum, which not only can guarantee that the QoS of all access users, but also can achieve the maximization of the throughput of the entire heterogeneous network.

The method provided by the embodiment of the present document is described in detail hereinafter.

In the embodiment of the present disclosure, an innovative resource allocation scheme for D2D communication in a small cell network is provided, which not only satisfies the QoS of all access users, but also the throughput of the entire heterogeneous network can reach the maximum value.

The method provided by the embodiments of the present disclosure finds the optimal solution of the problem by three steps:

when a D2D communication is not introduced, a feasible frequency resource allocation scheme of the Small Cell network is listed.

for each feasible frequency resource allocation scheme of the Small Cell network, the optimal D2D resource allocation scheme is sought by using the Block Coordinated Descent (BCD) optimization algorithm according to the maximum ratio policy; and

the total heterogeneous network capacities under the frequency resource allocation scheme of different Small Cell networks are analyzed and compared to find the approximate maximum value. At this point, the corresponding heterogeneous network frequency resource allocation scheme is the desired one.

The present disclosure includes two aspects: first, in the heterogeneous network composed of Small Cell and D2D, the allocation scheme for D2D communication resource by using the quasi-convex optimization theory and the maximum ratio policy (the ratio of D2D network throughput and Small Cell network throughput); second, in the heterogeneous network composed of Small Cell and D2D, under the premise of guaranteeing QoS requirement of each access user, the resource allocation scheme of the Small Cell and D2D users corresponding to the maximized total capacity of heterogeneous network. In addition, the present disclosure is not limited to the heterogeneous network composed of Small Cell and D2D, and other heterogeneous networks are similar. In the heterogeneous network composed of two different communication networks, the “maximum ratio” concept (that is, maximizing the capacity of another communication network when a communication network resource allocation scheme is determined) is also protected.

Hereinafter, the method provided in the embodiment of the present disclosure will be described in detail.

The set conditions are as follows: same-frequency multiplexing is performed inter-small-cell, and the orthogonal frequency resource is used in intra-small-cell; the same-frequency multiplexing is performed on the D2D communication and the Small Cell, and the same-frequency multiplexing is also performed among different D2D user pairs. Each UE is within the coverage of a Small cell Evolved NodeB (SeNB) in an exact open access state, and each SeNB has a specific Identification (ID). The IDs of all SeNBs in the dense network are configured as a set [symbol] ={1, . . . , z, . . . , I}. The total bandwidth is divided into K Resource Blocks (RBs) with the same size, and the numbered set is [symbol] ={1, . . . , k, . . . , K}. [symbol] ={1, . . . , m, . . . , M} is used to represent a set of all Small Cell UEs (SUEs) in the system, and [symbol] ᵢ⊂ [symbol] is used to represent a set of SUEs serviced by SeNBᵢ. [symbol] ={1, . . . , n, . . . , N} is used to represent a set of communication pairs (D_Tx (D2D transmitter): N, D_Rx (D2D receiver): N) of all D2D UEs (DUEs) in the system. p_{m,k}^{SUE} represents the transmission power for the SeNB on the RB k to [symbol] UEₘ. Signal to Interference plus Noise Ratio (SINR) of downlink [symbol] UEₘ (mε [symbol] ᵢ) on the RB k may be expressed as:

$${γ}_{m , k}^{SUE} = \frac{{p}_{m , k}^{SUE} \cdot {h}_{i , m , k}^{1}}{{\sum }_{n = 1}^{N} {p}_{n , k}^{DUE} \cdot {h}_{m , n , k}^{2} + {\sum }_{j \neq i , {m}^{′} ∈ {M}_{j}} {p}_{{m}^{′} , k}^{SUE} \cdot {h}_{j , m , k}^{1} + {n}_{0}} \qquad ( 1 )$$

Herein,

h_{i,m,k}¹ represents a channel gain between SeNBᵢ and SUEₘ on RB k;

h_{m,n,k}² represents a channel gain between SUEₘ and D2D transmitter n on the RB k;

p_{n,k}^{DUE} represents transmission power of DUEₙ on the RB k; and

n₀ represents background noise.

The SINR of downlink DUEₙ (nε [symbol] ) on the RB k may be expressed as:

$${γ}_{n , k}^{DUE} = \frac{{p}_{n , k}^{DUE} \cdot {h}_{n , n , k}^{3}}{{\sum }_{m = 1}^{M} {p}_{m , k}^{SUE} \cdot {h}_{m , n , k}^{4} + {\sum }_{{n}^{′} \neq n} {p}_{{n}^{′} , k}^{DUE} \cdot {h}_{{n}^{′} , n , k}^{5} + {n}_{0}} \qquad ( 2 )$$

Herein,

h_{n,n,k}³ represents a channel gain between the D2D transmitter n and the receiver n on the RB k;

h_{m,n,k}⁴ represents a channel gain between SeNBₘ and D2D receiver non the RB k;

h_{n,n,k}⁵ represents a channel gain between the D2D launcher n′ and the receiver n on the RB k.

Since the D2D link transmission power is small, the effects of farther D2D links are ignored, and expression (2) may be simplified as follows:

$${γ}_{n , k}^{DUE} = \frac{{p}_{n , k}^{DUE} \cdot {h}_{n , n , k}^{3}}{{\sum }_{m = 1}^{M} {p}_{m , k}^{SUE} \cdot {h}_{m , n , k}^{4} + {n}_{0}} \qquad ( 3 )$$

Then, the throughput of SUEₘ on the RB k is expressed as:

U_{m,k}^{SUE}=B₀·log(1+γ_{m,k}^{SUE}) (4)

The throughput of DUEₙ on the RB k is expressed as:

U_{n,k}^{DUE}=B₀·log(1+γ_{n,k}^{DUE}) (5)

herein, B₀ is the bandwidth of a single RB.

Then, the throughput of the entire network is expressed as:

$$U = {\sum }_{k = 1}^{K} {\sum }_{m = 1}^{M} {U}_{m , k}^{SUE} + {\sum }_{k = 1}^{K} {\sum }_{n = 1}^{N} {U}_{n , k}^{DUE} \qquad ( 6 )$$

At the same time, the following constraints must be met:

$$\begin{matrix}{γ}_{n , k}^{DUE} \geq {γ}_{th}^{DUE} & ( 6 a ) \\ {γ}_{m , k}^{SUE} \geq {γ}_{th}^{SUE} & ( 6 b ) \\ {\sum }_{m ∈ {M}_{i}} {\sum }_{k = 1}^{K} {p}_{m , k}^{SUE} \leq {P}_{max}^{SeNB} ∀ i ∈ ℐ & ( 6 c ) \\ {\sum }_{k = 1}^{K} {P}_{n , k}^{DUE} \leq {P}_{max}^{DUE} ∀ n ∈ 𝒩 & ( 6 d ) \\ {p}_{m , k}^{SUE} \geq 0 , {p}_{n , k}^{DUE} \geq 0 & ( 6 e )\end{matrix}$$

Herein,

Pₘₐₓ^{SeNB} represents maximum transmission power of Small Cell base station;

Pₘₐₓ^{DUE} represents maximum transmission power of the D2D UE.

The matrix, composed of the element p_{m,k}^{SUE}, P_{SUE}εR^{M×K}, and the matrix, composed of the element p_{n,k}^{DUE}, P^{DUE}εR^{N×K}.

Assumed that P^{SUE} is given, the two-dimensional matrixes X and Y (XεR^{M×K},YεR^{N×K}) are introduced. Elements x_{m,k} of X is a binary variable, and x_{m,k}=1 represents RB k is assigned to SUEₘ. Similarly, Elements y_{n,k} of Y is a binary variable, and y_{n,k}=1 represents RB k is assigned to DUEₙ. The objective function is transformed as follows:

U(P^{SUE},P^{DUE})→U′(X,P^{DUE})

Since the LTE downlink does not use power control, it can be assumed that the transmission power of the SeNB on each RB is fixed and identical, that is,

$${p}_{m , k}^{SUE} = \{ \begin{matrix}{P}_{max}^{SUE} / K & {x}_{m , k} = 1 \\ 0 & {x}_{m , k} = 0\end{matrix}$$

A matrix X*εR^{M×K} is used to represent the allocation matrix of the Resource Blocks (RBs) of the small cell in the heterogeneous network after the introduction of the D2D communication, and the matrix variables P^{DUE} is rewritten

$$T = \{ {p}_{1 , 1}^{DUE} , … , {p}_{1 , K}^{DUE} , {p}_{2 , 1}^{DUE} , … , {p}_{N , K}^{DUE} \} .$$

In this way, the objective function is rewritten as:

U′=u₁(X*,T)+u₂(X*,T) (7)

herein, u₁(T) represents the capacity of all SUES, and u₂(T) represents the capacity of all D2D communications.

All feasible resource allocation schemes of the heterogeneous network are listed to be Ω={X₁*, X₂*, . . . , X_{β}*} by using the exhaustive manner, herein,

$$β \leq {\sum }_{i = 1}^{I} K \cdot \vert {ℳ}_{i} \vert .$$

For each feasible scheme Xᵢ* (=1, 2, . . . , β), the D2D frequency resource allocation scheme T is optimized based on convex optimization theory.

For given X*, the optimization process is as follows:

It can be proved that, in the case of given X*, the function u₁(T) is a convex function, and u₂(T) is a concave function. We define the function ƒ(T)=u₁(T)/u₂(T), then ƒ(T) is a quasi-convex function with non-increasing property.

In this way, the objective function is rewritten as U′=u₁(T)(1+1/ƒ(T)).

The minimum of ƒ(T) and the corresponding D2D resource allocation scheme is obtained by a BCD algorithm in the convex optimization theory.

Assumed that the result obtained by the BCD algorithm is ρ, that is, in the case of the given X*, the maximum ratio of D2D communication capacity to Small Cell communication capacity is 1/ρ. Then, the capacity of the entire heterogeneous network may be obtained as follows:

U≈u_{0,th}·(1+1/ρ)

herein, u_{0,th} is the Small Cell communication capacity when conditional expression (6a) takes the equal sign (that is, the minimum that satisfies the user performance of the SINR of the SUE on the downlink RB k).

The calculation of heterogeneous network capacity is briefly described below.

Heterogeneous network capacity is U=u₁*+u₂*. Before introducing D2D communication, Small Cell network capacity is u₀. After introducing D2D communication, Small Cell network capacity u₁*(u₁*ε(u_{0,th},u₀) is reduced, taking u₁≈u_{0,th}. While the optimized D2D communication capacity is u₂*=u₁*/ρ, so the capacity of heterogeneous network is approximately obtained to be U≈u_{0,th}(1+1/ρ).

Then, through the above expression, system capacity values of the heterogeneous network under all optimization schemes are calculated, and a maximum value and an optimization scheme corresponding to the maximum value of the capacity are found from the system capacity values. By exhausting all feasible schemes and optimizing and comparing, the resource allocation scheme with the maximum throughput of the entire heterogeneous network can be obtained under the premise of guaranteeing QoS of all the access users.

The new type of heterogeneous network resource allocation scheme provided by the present embodiment has at least the following advantages: the method can provide a resource allocation scheme which can satisfy the QoS of all the access users, and find one resource allocation scheme in which the throughput of the heterogeneous network can reach the maximum value. In this way, it not only guarantees the QoS of all access users, but also achieves the maximization of the throughput of the entire heterogeneous network.

The embodiment of the present disclosure implements an innovative resource allocation scheme for the Small cell network where D2D communication is introduced. The following is a detailed description of the application in the Small cell network resource allocation where D2D communication is introduced in the embodiment of the present disclosure.

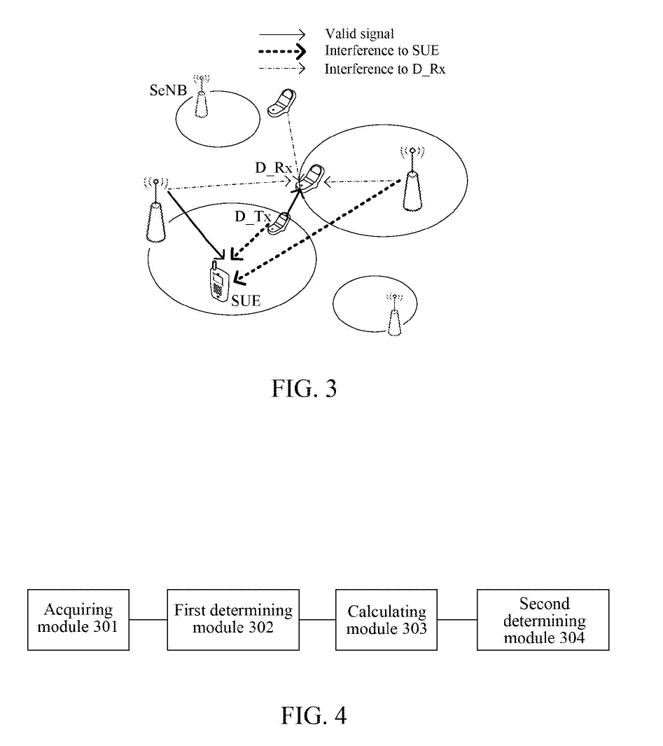

As shown in FIG. 3, when only the downlink is considered, any SUE will be subject to interference from other SeNB and D2D UE pairs except for its own SeNB. The receiver D_Rx of any D2D UE will be interfered by other DUE transmitters D_Rx and the surrounding SeNB.

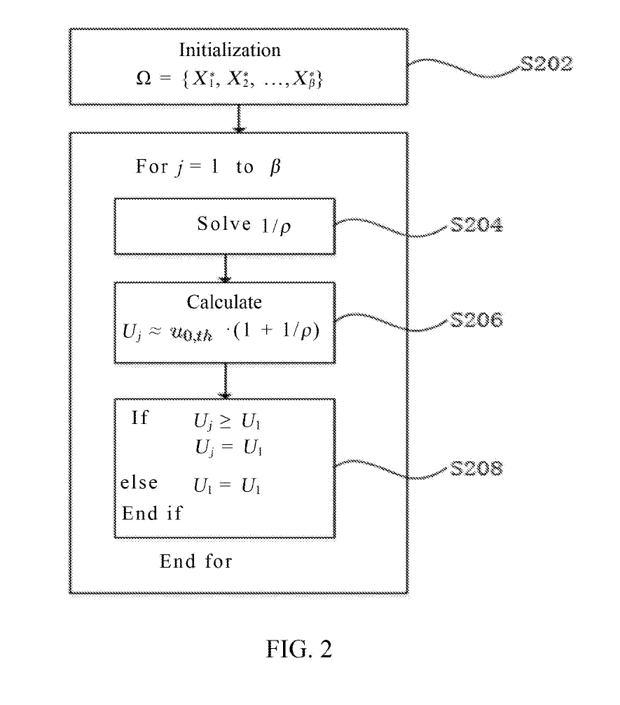

FIG. 2 is a flowchart of a method for acquiring a resource allocation scheme of a heterogeneous network provided by an embodiment of the present disclosure. As shown in FIG. 2, the method includes the following steps S202-S208.

In step S202, when D2D communication is not introduced, all feasible network frequency resource allocation schemes of Small Cell network are listed to be Ω={X₁*, X₂*, . . . , X_{β}*}.

In step S204, for each feasible scheme, based on the convex optimization theory, the maximum ratio 1/ρ of the D2D communication capacity to the small cell network capacity is found, and the corresponding D2D resource allocation scheme is obtained.

In step S206, the capacity Uⱼ of the heterogeneous network after optimizing each scheme is calculated.

In step S208, total heterogeneous network capacities under different Small Cell network frequency resource allocation schemes are analyzed and compared, and an approximate maximum and a resource allocation scheme corresponding to the maximum are found.

It can be seen from the above, the system capacity values of the heterogeneous network system under all optimization schemes are calculated, and the maximum value and the optimization scheme corresponding to the maximum value of the capacity are found. By exhausting all feasible schemes and optimizing and comparing, the resource allocation scheme with the maximum throughput of the entire heterogeneous network can be obtained under the premise of guaranteeing the QoS of all the access users.

The new type of heterogeneous network resource allocation scheme provided by the present embodiment has at least the following advantages: a resource allocation scheme which can satisfy the QoS of all the access users can be provided, and one resource allocation scheme where the throughput of heterogeneous network can reach the maximum value can be found. In this way, it not only guarantees the QoS of all access users, but also achieves the maximization of the throughput of the entire heterogeneous network.

FIG. 4 is a structural schematic diagram of an apparatus for acquiring a management policy of a heterogeneous network provided by an embodiment of the present disclosure. In combination with the method shown in FIG. 1 and FIG. 2, the apparatus shown in FIG. 4 includes an acquiring module 301, a first determining module 302, a calculating module 303 and a second determining module 304.

The acquiring module 301 is configured to acquire a feasible frequency allocation policy of a small cell network when there is only the small cell network in the heterogeneous network.

The first determining module 302 is configured to, in each frequency allocation policy, when the heterogeneous network includes a device-to-device network, determine an optimal resource allocation policy of the device-to-device network.

The calculating module 303 is configured to calculate a capacity of the heterogeneous network under each frequency allocation policy and the optimal resource allocation policy corresponding to the each frequency allocation policy, obtain at least two capacities of the heterogeneous network.

The second determining module 304 is configured to obtain the frequency allocation policy and the resource allocation policy of the heterogeneous network according to at least two capacities of the heterogeneous network.

Herein, the first determining module 302 is configured to,

in each frequency allocation policy, determine the optimal resource allocation policy of D2D network by using a block coordinated descent optimization algorithm and by calculating a ratio of a throughput of the device to device network to a throughput of the small cell network.

Herein, the calculating module 303 is configured to, according to u_{0,th} and ρ, determine the capacity of the heterogeneous network under each frequency allocation policy and the optimal resource allocation policy corresponding to the each frequency allocation policy.

Herein, u_{0,th} is a communication capacity of the small cell network, when γ_{n,k}^{DUE}=γₜₕ^{DUE}, and γ_{n,k}^{DUE} represents a Signal to Interference plus Noise Ratio (SINR) of an nth terminal of the small cell network on a kth resource block, and γₜₕ^{DUE} represents a preset SINR threshold value of a receiving end of the device to device network.

Herein, ρ represents a maximum ratio of the communication capacity of the small cell network to the communication capacity of the device-to-device network.

Herein,

$${γ}_{n , k}^{DUE} = \frac{{p}_{n , k}^{DUE} \cdot {h}_{n , n , k}^{3}}{{\sum }_{m = 1}^{M} {p}_{m , k}^{SUE} \cdot {h}_{m , n , k}^{4} + {n}_{0}}$$

herein, p_{n,k}^{DUE} represents transmission power of the D2D terminal numbered n on the kth resource block RB;

h_{n,n,k}³ represents a channel gain between nth D2D transmitter and nth receiver on the kth bandwidth RB;

p_{m,k}^{SUE} represents transmission power for a small cell evolved base station SeNB on the kth bandwidth RB to an mth small cell terminal SUEₘ;

h_{m,n,k}⁴ represents a channel gain between a small cell evolved base station SeNBₘ numbered m and nth D2D receiver on the kth bandwidth RB; and

n₀ represents background noise.

Herein, the capacity of the heterogeneous network is U=u_{0,th}·(1+1/ρ); herein,

$${u}_{0 , th} = {\sum }_{k = 1}^{K} {M}_{m = 1} {x}_{m , k} \cdot {B}_{0} \cdot log ( 1 + {γ}_{th}^{SUE} )$$

herein, k represents a kth bandwidth in a downlink total bandwidth with K bandwidths, [symbol] ={1, . . . , k, . . . , K};

m represents an mth terminal in a total number of M terminals of the heterogeneous network, [symbol] ={1, . . . , m, . . . , M};

x_{m,k}=1 represents that the kth resource block is allocated to the small cell network user equipment m, and x_{m,k}=0 represents that the kth resource block is not allocated to the small cell network user equipment m;

B₀ represents a unit resource block bandwidth size; and

γₜₕₑ^{SUE} represents a preset SINR threshold value of the receiving end in the small cell network.

The second determining module is configured to, according to a maximum value of at least two capacities of the heterogeneous network, determine the frequency allocation policy and the resource allocation policy of the heterogeneous network corresponding to the maximum value.

The apparatus provided by the embodiment of the present disclosure can provide a resource allocation scheme that satisfies the QoS of all access users, and finds one resource allocation scheme where the throughput of the heterogeneous network can reach the maximum, which not only can guarantee that the QoS of all access users, but also can achieve the maximization of entire heterogeneous network throughput.

In addition, the embodiment of the present disclosure further provides a computer-readable storage medium storing a computer-executable instruction, and when the computer-executable instruction is executed, it can implement the above-mentioned method for acquiring a management policy of the heterogeneous network.

Those ordinarily skilled in the art can understand that all or some of steps of the abovementioned method may be completed by the programs instructing the relevant hardware (such as, processors), and the programs may be stored in a computer-readable storage medium, such as, read only memory, magnetic or optical disk. In an exemplary embodiment, all or some of the steps of the abovementioned embodiments may also be implemented by using one or more integrated circuits. Accordingly, the modules/units in the above embodiments may be implemented in the form of hardware, for example, by means of an integrated circuit to implement its corresponding function, or may be implemented in the form of a software function module, for example, executing a program/instruction stored in a memory to implement its corresponding function by a processor. The present disclosure is not limit to any specific form of the combination of the hardware and software.

The above description is only alternative embodiments of the present disclosure, and is not intended to limit the protective scope of the present disclosure. Any modifications, equivalent substitutions and improvements made within the essence and principle of the present disclosure should be included in the protection scope of the present disclosure.

### INDUSTRIAL APPLICABILITY

Embodiments of the present disclosure provide a method and an apparatus for acquiring a management policy of a heterogeneous network, which can provide a resource allocation scheme that satisfies the QoS of all access users, and finds one resource allocation scheme where the throughput of the heterogeneous network can reach the maximum. Therefore, the method and the apparatus for acquiring a management policy of a heterogeneous network not only can guarantee that the QoS of all access users, but also can achieve the maximization of the throughput of the entire heterogeneous network.

What is claimed is:

1. A method for acquiring a management policy of a heterogeneous network, comprising:
when there is only a small cell network in the heterogeneous network, acquiring a feasible frequency allocation policy of the small cell network;
in each frequency allocation policy, when the heterogeneous network comprises a device-to-device, D2D, network, determining an optimal resource allocation policy of the device-to-device network;
calculating a capacity of the heterogeneous network under the each frequency allocation policy and the optimal resource allocation policy corresponding to the each frequency allocation policy, obtaining at least two capacities of the heterogeneous network; and
obtaining a frequency allocation policy and a resource allocation policy of the heterogeneous network according to the at least two capacities of the heterogeneous network.

2. The method of claim 1, wherein, in each frequency allocation policy, when the heterogeneous network comprises a device-to-device network, the determining an optimal resource allocation policy of the device-to-device network, comprises:
in the each frequency allocation policy, determining the optimal resource allocation policy of the D2D network by using a block coordinated descent optimization algorithm and by calculating a ratio of a throughput of the device to device network to a throughput of the small cell network.

3. The method of claim 1, wherein, the calculating a capacity of the heterogeneous network under the each frequency allocation policy and the optimal resource allocation policy corresponding to the each frequency allocation policy comprises:
according to u_{0,th} and ρ, determining the capacity of the heterogeneous network under the each frequency allocation policy and the optimal resource allocation policy corresponding to the each frequency allocation policy;
wherein, u_{0,th} is a communication capacity of the small cell network when γ_{n,k}^{DUE}=γₜₕ^{DUE}; wherein, γ_{n,k}^{DUE} represents a Signal to Interference plus Noise Ratio, SINR, of an nth terminal of the small cell network on a kth resource block; and γₜₕ^{DUE} represents a preset SINR threshold value of a receiving end of the device to device network; and
wherein, ρ represents a maximum ratio of the communication capacity of the small cell network to the communication capacity of the device-to-device network.

4. The method of claim 3, wherein,
$${γ}_{n , k}^{DUE} = \frac{{p}_{n , k}^{DUE} \cdot {h}_{n , n , k}^{3}}{{\sum }_{m = 1}^{M} {p}_{m , k}^{SUE} \cdot {h}_{m , n , k}^{4} + {n}_{0}}$$
wherein, p_{n,k}^{DUE} represents transmission power of a D2D terminal numbered n on the kth resource block RB;
h_{n,n,k}³ represents a channel gain between an nth D2D transmitter and an nth receiver on the kth bandwidth RB;
p_{m,k}^{SUE} represents transmission power for a small cell evolved base station SeNB on the kth bandwidth RB to an mth small cell terminal [symbol] UEₘ;
h_{m,n,k}⁴ represents a channel gain between a small cell evolved base station [symbol] eNBₘ numbered m and the nth D2D receiver on the kth bandwidth RB; and
n₀ represents background noise.

5. The method of claim 3, wherein,
the capacity of the heterogeneous network is U≈u_{0,th}·(1+1/ρ); wherein:
$${u}_{0 , th} = {\sum }_{k = 1}^{K} {M}_{m = 1} {x}_{m , k} \cdot {B}_{0} \cdot log ( 1 + {γ}_{th}^{SUE} )$$
wherein, k represents a kth bandwidth in a downlink total bandwidth with K bandwidths, [symbol] ={1, . . . , k, . . . , K};
wherein, m represents an mth terminal in terminals, a total number of which is M, of the heterogeneous network, [symbol] ={1, . . . , m, . . . , M};
wherein, x_{m,k}=1 represents that the kth resource block is allocated to the small cell network user equipment m; x_{m,k}=0 represents that the kth resource block is not allocated to the small cell network user equipment m;
wherein, B₀ represents a bandwidth size of a unit resource block; and
wherein, γₜₕ^{SUE} represents a preset SINK threshold value of the receiving end in the small cell network.

6. The method of claim 1, wherein, the obtaining a frequency allocation policy and a resource allocation policy of the heterogeneous network according to the at least two capacities of the heterogeneous network, comprises: according to a maximum value of the at least two capacities of the heterogeneous network, determining the frequency allocation policy and the resource allocation policy of the heterogeneous network corresponding to the maximum value.

7. An apparatus for acquiring a management policy of a heterogeneous network, comprising:
an acquiring module configured to, when there is only a small cell network in the heterogeneous network, acquire a feasible frequency allocation policy of the small cell network;
a first determining module configured to, in each frequency allocation policy, when the heterogeneous network comprises a device-to-device, D2D, network, determine an optimal resource allocation policy of the device-to-device network;
a calculating module configured to calculate a capacity of the heterogeneous network under the each frequency allocation policy and the optimal resource allocation policy corresponding to the each frequency allocation policy, obtain at least two capacities of the heterogeneous network; and
a second determining module configured to obtain the frequency allocation policy and the resource allocation policy of the heterogeneous network according to at least two capacities of the heterogeneous network.

8. The apparatus of claim 7, wherein, the first determining module is configured to:
in the each frequency allocation policy, determine the optimal resource allocation policy of the D2D network by using a block coordinated descent optimization algorithm and by calculating a ratio of a throughput of the device to device network to a throughput of the small cell network.

9. The apparatus of claim 7, wherein, the calculating module is configured to:
according to u_{0,th} and ρ, determine the capacity of the heterogeneous network under the each frequency allocation policy and the optimal resource allocation policy corresponding to the each frequency allocation policy;
wherein, u_{0,th} is a communication capacity of the small cell network when γ_{n,k}^{DUE}=γₜₕ^{DUE}; wherein, γ_{n,k}^{DUE} represents a Signal to Interference plus Noise Ratio, SINR, of an nth terminal of the small cell network on a kth resource block; and γₜₕ^{DUE} represents a preset SINR threshold value of a receiving end of the device to device network; and
wherein, ρ represents a maximum ratio of the communication capacity of the small cell network to the communication capacity of the device-to-device network.

10. The apparatus of claim 9, wherein,
$${γ}_{n , k}^{DUE} = \frac{{p}_{n , k}^{DUE} \cdot {h}_{n , n , k}^{3}}{{\sum }_{m = 1}^{M} {p}_{m , k}^{SUE} \cdot {h}_{m , n , k}^{4} + {n}_{0}}$$
wherein, p_{n,k}^{DUE} represents transmission power of the D2D terminal numbered n on the kth resource block RB;
h_{n,n,k}³ represents a channel gain between an nth D2D transmitter and an nth receiver on the kth bandwidth RB;
p_{m,k}^{SUE} represents transmission power for a small cell evolved base station SeNB on the kth bandwidth RB to an mth small cell terminal [symbol] UEₘh_{m,n,k}⁴ represents a channel gain between a small cell evolved base station [symbol] eNBₘ numbered m and the nth D2D receiver on the kth bandwidth RB; and
n₀ represents background noise.

11. The apparatus of claim 9, wherein,
the capacity of the heterogeneous network is U≈u_{0,th}·(1+1/ρ); wherein:
$${u}_{0 , th} = {\sum }_{k = 1}^{K} {M}_{m = 1} {x}_{m , k} \cdot {B}_{0} \cdot log ( 1 + {γ}_{th}^{SUE} )$$
wherein, k represents a kth bandwidth in a downlink total bandwidth with K bandwidths, [symbol] ={1, . . . , k, . . . , K};
wherein, m represents an mth terminal in terminals, a total number of which is M, of the heterogeneous network, [symbol] ={1, . . . m, . . . , M};
wherein, x_{m,k}=1 represents that the kth resource block is allocated to the small cell network user equipment m; and x_{m,k}=0 represents that the kth resource block is not allocated to the small cell network user equipment m;
wherein, B₀ represents a bandwidth size of a unit resource block; and
wherein, γₜₕ^{SUE} represents a preset SINK threshold value of the receiving end in the small cell network.

12. The apparatus of claim 7, wherein, the second determining module is configured to, according to a maximum value of the at least two capacities of the heterogeneous network, determine the frequency allocation policy and the resource allocation policy of the heterogeneous network corresponding to the maximum value.

13. A computer-readable storage medium storing a computer-executable instruction, wherein when executed, the computer-executable instruction implements the method of claim 1.

14. A computer-readable storage medium storing a computer-executable instruction, wherein when executed, the computer-executable instruction implements the method of claim 2.

15. A computer-readable storage medium storing a computer-executable instruction, wherein when executed, the computer-executable instruction implements the method of claim 3.

16. A computer-readable storage medium storing a computer-executable instruction, wherein when executed, the computer-executable instruction implements the method of claim 4.

17. A computer-readable storage medium storing a computer-executable instruction, wherein when executed, the computer-executable instruction implements the method of claim 5.

18. A computer-readable storage medium storing a computer-executable instruction, wherein when executed, the computer-executable instruction implements the method of claim 6.
